(19) United States
(12) Patent Application Publication
(10) Pub. No.: US 2010/0115236 A1
(43) Pub. Date: May 6, 2010

(54) HIERARCHICAL SHARED SEMAPHORE REGISTERS

(75) Inventors: Abdulla Bataineh, Chippewa Falls, WI (US); James Robert Kohn, Mendota Heights, MN (US); Eric P. Lundberg, Chippewa Fall, WI (US); Timothy J. Johnson, Chippewa Falls, WI (US); Thomas L. Court, Chippewa Falls, WI (US); Gregory J. Faanes, Chippewa Falls, WI (US); Steven L. Scott, Chippewa Falls, WI (US)

Correspondence Address: SCHWEGMAN, LUNDBERG & WOESSNER, P.A., P.O. BOX 2938, MINNEAPOLIS, MN, 55402, US

(73) Assignee: Cray inc., seattle, WA (US)

(21) Appl. No.: 12/263,305

(22) Filed: Oct. 31, 2008

(51) Int. Cl. G06F 15/76; G06F 9/06

(52) U.S. Cl. 712/29; 712/E09.003

(57) ABSTRACT

A multiprocessor computer system having a plurality of processing elements comprises one or more core-level hierarchical shared semaphore registers, wherein each core-level hierarchical shared semaphore register is coupled to a different processor core. Each hierarchical shared semaphore register is writable to each of a plurality of streams executing on the coupled processor core. One or more chip-level hierarchical shared semaphore registers are also coupled to plurality of processor cores, each chip-level hierarchical shared semaphore register writable to each of the plurality of processor cores.

### FIELD OF THE INVENTION

The invention relates generally to computer processors, and more specifically in one embodiment to hierarchical shared semaphore registers.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Most general purpose computer systems are built around a processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

In more sophisticated computer systems, multiple processors are used, and one or more processors runs software that is operable to assign tasks to other processors or to split up a task so that it can be worked on by multiple processors at the same time. In such systems, the data being worked on is typically stored in memory that is either centralized, or is split up among the different processors working on a task.

Instructions from the instruction set of the computer's processor or processor that are chosen to perform a certain task form a software program that can be executed on the computer system. Typically, the software program is first written in a high-level language such as “C” that is easier for a programmer to understand than the processor's instruction set, and a program called a compiler converts the high-level language program code to processor-specific instructions.

In multiprocessor systems, the programmer or the compiler will usually look for tasks that can be performed in parallel, such as calculations where the data used to perform a first calculation are not dependent on the results of certain other calculations such that the first calculation and other calculations can be performed at the same time. The calculations performed at the same time are said to be performed in parallel, and can result in significantly faster execution of the program. Although some programs such as web browsers and word processors don't consume a high percentage of even a single processor's resources and don't have many operations that can be performed in parallel, other operations such as scientific simulation can often run hundreds or thousands of times faster in computers with thousands of parallel processing nodes available.

Multiple operations can also be performed at the same time using one or more vector processors, which perform an operation on multiple data elements at the same time. For example, rather than instruction that adds two numbers together to produce a third number, a vector instruction may add elements from a 64-element vector to elements from a second 64-element vector to produce a third 64-element vector, where each element of the third vector is the sum of the corresponding elements in the first and second vectors.

But, when multiple processors are working on the same task, different processors may need to work with the same data, and may change the data such that the copies of the data held in other processors is no longer valid unless it is completed before the data is changed or is updated. These and other data dependency problems are sometimes addressed by use of barriers or other synchronization methods, ensuring that two or more thread working on a particular task are at a desired point in execution at the same time. In a traditional barrier, two or more threads working on a task stop processing when they reach a barrier point until all such threads have reached the barrier, and then all threads proceed with execution.

For example, in a scientific ocean study application in which the temperatures and currents of an ocean are characterized in a large array, operations on the array must generally complete one entire iteration before any processor can proceed to the next iteration, so that the ocean modeling data being used by the various processors is always on the same iteration. Barriers are used to halt each processor's execution of the model processing thread as each processor completes its tasks for the given iteration, until all parallel threads have also finished processing the same iteration. Once all threads have finished an iteration, they all reach the barrier point in the executable program, and proceed as a group onto the next iteration.

It is therefore desirable to manage barriers, synchronization, and related functions within a parallel processing computer system.

### SUMMARY

Some embodiments of the invention comprise various configurations of shared hierarchical semaphore registers in a multiprocessor computer system. In one example, a multiprocessor computer system having a plurality of processing elements comprises one or more core-level hierarchical shared semaphore registers, wherein each core-level hierarchical shared semaphore register is coupled to a different processor core. Each hierarchical shared semaphore register is writable to each of a plurality of streams executing on the coupled processor core. One or more chip-level hierarchical shared semaphore registers are also coupled to plurality of processor cores, each chip-level hierarchical shared semaphore register writable to each of the plurality of processor cores.

### BRIEF DESCRIPTION OF THE FIGURES

FIG. 1 shows a multiprocessor computer system having multiple cores per chip and multiple chips per node, consistent with an example embodiment of the invention.

FIG. 2 shows a flowchart illustrating a method of using a hierarchical shared semaphore register to provide program stream synchronization, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or applications. Other embodiments of the invention exist and are within the scope of the invention, and logical, mechanical, electrical, and other changes may be made without departing from the scope or subject of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Multiprocessor computer systems often rely on various synchronization functions to ensure that various operations are performed at the desired time, such as to ensure that the data being used in the operation is the desired data, and has not been changed or does not change data still needed by other processors. This is often performed by a variety of operations known as blocking or barrier functions, which are operable to halt execution of threads or processes until all other designated processes also reach the barrier, at which point all threads can proceed.

A shared counter is often used to track threads that reach a barrier, such that the counter counts the number of processes or threads that have arrived at the barrier. For example, if 32 different threads are all operating on the same data set and performing operations in parallel, the counter will eventually be incremented up to 32 as each of the threads reaches the barrier and increments the counter. Once the counter reaches 32, the threads are notified that all threads have reached the barrier, and all threads can proceed.

The threads increment the counter, and check the counter value to see if the the counter is equal to the number of processes being synchronized. If the counter value is not yet equal to the number of processes, the incrementing process will wait and monitor a flag value until the flag changes state. If the counter value is equal to the number of processes that are being synchronized via the barrier, the process changes the flag state so that other processes know that all processes have reached the barrier. The other processes recognize the flag's change in state, and can proceed with execution.

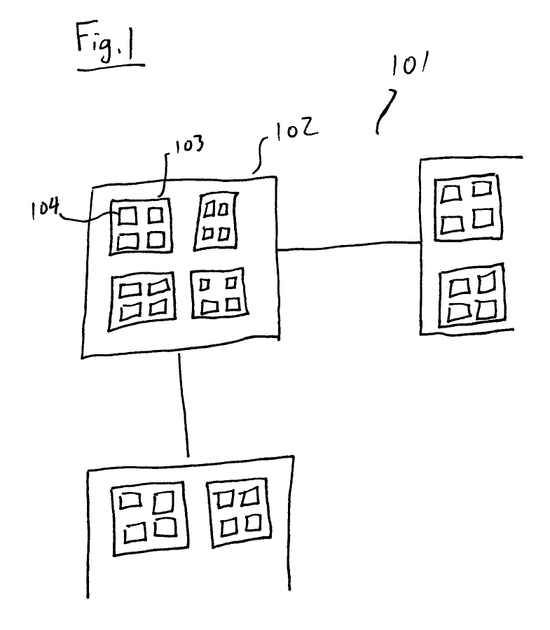

But, coordination of synchronization via barriers or other methods becomes more complex in multiprocessor computer environments featuring large numbers of processors or architectures having multiple hierarchical levels. One such example multiprocessor computer system is illustrated in FIG. 1, which may be used to practice some example embodiments of the invention.

A multiprocessor computer system 101 comprises several computing nodes 102, which are linked to one another by a network. The network has different topologies in different embodiments, such as a torus, a cube or hypercube, or a butterfly topology. The nodes are able to pass messages to one another via the network, such as to share data, distribute executable code, access memory in another node, and for other functions.

Each of the nodes 102 comprises a plurality of chips, including in this example four processor chips 103. A variety of other chips may be present, such as a memory controller, memory, a network controller, and different types of processors such as vector and scalar processor chips. Each processor chip in this example further comprises four independent processor cores 104, each processor core operable to act as an individual computer processor, much as if four separate standalone computer processors were combined on the same chip.

The complexity of sharing information between processors is increased in this example, as different processor cores in the multiprocessor computer system can be more or less local to a certain processor core than other processor cores. For example, two cores may be on the same chip, may be on different chips in the same processing node, or may be on entirely different processing nodes. The delay in sending messages from one processor core to another rises significantly when the processor is remote, such as on another chip or on another node, which sows down the overall performance of the computer system.

One example embodiment of the invention addresses problems such as this by using a hierarchical shared semaphore, which in this example uses one or more shared registers to store synchronization data.

In one such embodiment, a hierarchy of registers is used to accumulate semaphore data to synchronize program execution across multiple levels of processor configuration. Referring again to FIG. 1, each processor core 104 has a shared semaphore register used for synchronization between streams or processes of the same application running on the same processor core, and each processor chip 103 has a shared semaphore register used for synchronization among threads or processes running on the same chip but on two or more different cores. In a further embodiment, each node also includes a shared semaphore register used to synchronize program execution across streams or threads running on different chips within the same node. Various embodiments are therefore able to provide chip level ordering, node level ordering, or global synchronization of thread or process execution.

In a more complex example, multiple levels of hierarchal semaphore registers are used to synchronize a single group of threads or streams. For example, if streams that are synchronized such as by using barriers for a given application are spread across three nodes such as nodes 102 of FIG. 1, the various streams may be spread across four cores per chip, four chips per node, and three nodes, for a total of three levels of hierarchy and 48 processor cores. Considering that each core may have multiple executing streams, more than 48 node-to-node messages may be needed to synchronize the streams using a single hierarchical node-level semaphore register. In a further embodiment in which each chip comprises 32 processor cores rather than four, the advantages of such a system of hierarchical shared semaphore registers become even more apparent.

In this multiple level synchronization example, local semaphore registers on each core can be used to track when all the streams on the core have reached the barrier, at which point a single message is sent from the core-level hierarchical shared register to the chip-level register. The chip-level register therefore counts cores that have reported in rather than individual streams, and needs only 32 messages rather than the hundreds that may be needed to track each stream on each core of the chip. Similarly, the various chips in turn sends a message to a coordinating node's semaphore register only when all cores have reported to the chip that their respective streams have reached a synchronization point, so that each core, chip, or node only reports once, reflecting that all streams contained therein have reached the synchronization point. Even in a relatively simple example such as this one, using multiple-level hierarchical synchronization can reduce the number of network messages needed from hundreds or thousands down to only two, to coordinate streams across the three nodes.

The various streams in the above examples are synchronized in one embodiment by initializing a hierarchical semaphore register with a value indicating the number of streams to be synchronized. As each stream reaches the synchronization point, it notifies the hierarchical shared register, either by notifying the appropriate hierarchical shared register directly, or by notifying a local hierarchical shared semaphore register that in turn notifies a higher-level hierarchical shared semaphore register. The register value decrements on each notification, and upon reaching a zero value sends notification to all synchronized threads that the synchronization point is reached and execution can resume. Such a system therefore provides a mechanism for streams to sleep or become inactive while waiting for a synchronization event, as well as a mechanism for a single stream to wake up many sleeping streams when a barrier or other synchronization point is reached.

In a more detailed example, shared semaphore registers on a core can be accessed by all streams on the core, including the ability for any stream to write to the register. When a stream accesses the shared semaphore register and reads a result value other than zero, the stream automatically sleeps, or stops execution. Once a master stream or a final stream clears the semaphore value by decrementing its value to zero or otherwise resetting the value, all streams that are parked on the semaphore will resume execution. This is achieved in one example by using a 128-bit mask per semaphore register with each bit in the mask corresponding to a stream in the core. Each stream that is parked on the hierarchical shared semaphore register will have the bit corresponding to the stream set in the mask, so that the mask value can be used by the master stream to awaken the other parked streams.

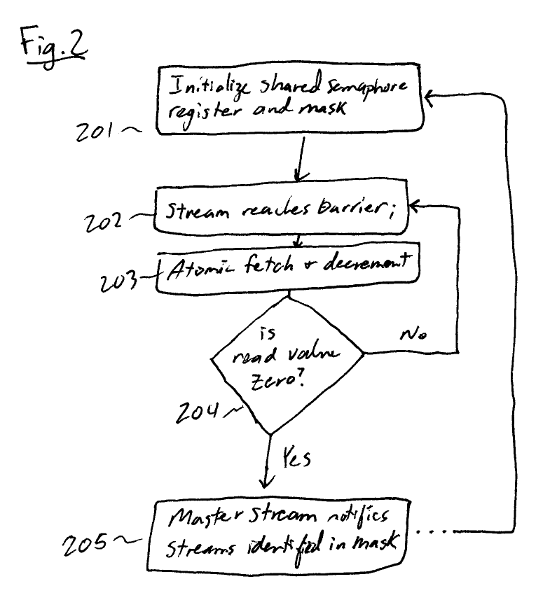

FIG. 2 is a flowchart, illustrating an example method of using a hierarchical shared semaphore register to provide program stream synchronization. At 201, a processor core's shared semaphore register is initialized with a value reflecting the number of streams that are being synchronized. This is performed in some embodiments by a master stream responsible for various synchronization functions, such as initialization of the semaphore register value and notification of the other threads when the semaphore value reaches zero. Here, a 128-bit mask associated with the core's semaphore register is also initialized, with a one value being set for each bit corresponding to a stream that is synchronized via the semaphore register. If 40 streams are synchronized, for example, 40 individual bits representing 40 streams should be set in the mask, and the semaphore register should be initialized with a value of 40.

At 202, various streams being synchronized begin reaching the synchronization or barrier point of the executing program. Once the stream reaches the synchronization point, it reads and decrements the shared semaphore value at 203, and if the decremented value is determined to be non-zero at 204, the process of decrementing the semaphore register value by one for each stream that reaches the synchronization point continues until all streams have finished and the semaphore register value is zero. Once the shared semaphore value is zero, the master stream notifies all streams identified in the mask that all streams have reached the synchronization point, and the streams resume execution. In an alternate embodiment, the final stream to reach the barrier recognizes that the decremented shared semaphore value is zero, and notifies one or more other threads that program execution can resume.

In another example, the various program elements being tracked via a hierarchical shared semaphore register may not be program threads, but may be other hierarchical shared semaphore registers on another hierarchical level, or other program elements. In this example, a shared semaphore register on a core may wait until all threads on the core have reached the barrier to notify a chip shared semaphore register, which in turn waits until all cores on the chip have reported that their associated threads have reached the barrier to notify a node level register or other logic. Once all chips in a node have reported that thread execution in the node's hierarchy have reached a barrier, the node notifies a master node shared hierarchical register that all threads, cores, and chips on the reporting node have reached the barrier or synchronization point.

The examples presented herein illustrate how a hierarchical system of shared registers can be used in a multiprocessor computer system to efficiently provide program synchronization functions, such as a register and mask used to notify coordinated streams when all streams have reached the barrier point and notified the semaphore register. Multiple level synchronization examples presented further illustrate how a hierarchical system of semaphore registers can be used to reduce network traffic. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A multiprocessor computer system, comprising:
a plurality of processor cores; and
one or more core-level hierarchical shared semaphore registers, wherein each core-level hierarchical shared semaphore register is coupled to a different processor core, each hierarchical shared semaphore register writable to each of a plurality of streams executing on the coupled processor core; and
one or more chip-level hierarchical shared semaphore registers, wherein each chip-level hierarchical shared semaphore register is coupled to plurality of processor cores, each chip-level hierarchical shared semaphore register writable to each of the plurality of processor cores.

2. The multiprocessor computer system of claim 1, further comprising a plurality of chips, each chip comprising a plurality of processor cores, and wherein each chip-level hierarchical shared semaphore register is associated with a specific chip.

3. The multiprocessor computer system of claim 1, further comprising:
a plurality of processing nodes, each node comprising a plurality of the processing cores; and
one or more node-level hierarchical shared semaphore registers, wherein each node-level hierarchical shared semaphore register is coupled to plurality of processor cores, each node-level hierarchical shared semaphore register writable to each of the plurality of processor cores

4. The multiprocessor computer system of claim 3, wherein each of the plurality of processing nodes comprises a plurality of chips, each chip comprising a plurality of processor cores.

5. The multiprocessor computer system of claim 1, further comprising a mask register comprising a plurality of bits, each of the plurality of bits corresponding to a synchronized program element.

6. The multiprocessor computer system of claim 1, wherein a vector operation is distributed among a plurality of cores that are synchronized via a shared semaphore register.

7. The multiprocessor system of claim 1, wherein the shared semaphore register is operable to count the number of associated program elements that have reached a barrier.

8. The multiprocessor system of claim 7, wherein the system is further operable to halt execution of associated program elements that have reached a barrier until all associated program elements have reached the barrier.

9. The multiprocessor system of claim 1, wherein one or more shared semaphore registers is further operable to notify a hierarchical shared semaphore register in a different hierarchical level when all associated program elements have reached a barrier.

10. A method of operating a multiprocessor computer system, comprising:
signaling a core-level hierarchical shared semaphore register from each of a plurality of streams executing on a coupled processor core upon the streams reaching a barrier point in execution; and
signaling a chip-level hierarchical shared semaphore register from each of a plurality of processor cores upon the streams executing in each of the processor cores reaching a barrier point in execution.

11. The method of operating a multiprocessor computer system of claim 10, wherein signaling the chip-level hierarchical shared semaphore register from a processor core comprises signaling only when all associated streams executing on the signaling processor core have reached the barrier point in execution.

12. The method of operating a multiprocessor computer system of claim 10, further comprising:
signaling a node-level hierarchical shared semaphore register from each of a plurality of chips upon the streams executing in each of the chips reaching a barrier point in execution.

13. The method of operating a multiprocessor computer system of claim 12, wherein each of the plurality of processing nodes comprises a plurality of chips, each chip comprising a plurality of processor cores.

14. The method of operating a multiprocessor computer system of claim 10, further comprising identifying synchronized program elements using a mask register comprising a plurality of bits, each of the plurality of bits corresponding to a synchronized program element.

15. The method of operating a multiprocessor computer system of claim 10, further comprising distributing a vector operation among a plurality of cores that are synchronized via a shared semaphore register.

16. The method of operating a multiprocessor system of claim 10, further comprising counting the number of associated program elements that have reached a barrier using one or more hierarchical shared semaphore registers.

17. The method of operating a multiprocessor system of claim 16, further comprising halting execution of associated program elements that have reached a barrier until all associated program elements have reached the barrier.

18. The method of operating a multiprocessor system of claim 10, further comprising notifying a hierarchical shared semaphore register notifying a hierarchical shared semaphore register in a different hierarchical level when all associated program elements have reached a barrier.

19. A multiprocessor computer system, comprising:
a plurality of processor cores;
a plurality of chips, each chip comprising a plurality of processing cores;
one or more hierarchical shared semaphore registers wherein each hierarchical shared semaphore register is coupled to a plurality of the processor cores and writeable to each of the plurality of processor cores; and
one or more hierarchical shared semaphore registers wherein each hierarchical shared semaphore register is coupled to a plurality of the chips and writeable to each of the plurality of chips.

20. A multiprocessor computer system, comprising:
a plurality of chips, each chip comprising one or more processor cores; and
one or more nodes, each node comprising a plurality of the chips;
one or more chip-level hierarchical shared semaphore registers, wherein each chip-level hierarchical shared semaphore register is coupled to a different chip, each hierarchical shared semaphore register writable to each of one or more processor cores on the chip; and
one or more node-level hierarchical shared semaphore registers, wherein each node-level hierarchical shared semaphore register is coupled to a different node, each node-level hierarchical shared semaphore register writable to each of the one or more coupled chips in the node.

21. The multiprocessor computer system of claim 20, further comprising a plurality of nodes, and one or more hierarchical shared semaphore registers wherein each hierarchical shared semaphore register is coupled to a plurality of nodes and writeable to each of the plurality of nodes.
